(19) United States
(12) Patent Application Publication
(10) Pub. No.: US 2016/0062738 A1
(43) Pub. Date: Mar. 3, 2016

(54) Methods and Apparatuses for Interactive Computer Programming

(71) Applicant: Anthony Mai, Mountain View, CA (US)

(72) Inventor: Anthony Mai, Mountain View, CA (US)

(73) Assignee: Anthony Mai, Mountain View, CA (US)

(21) Appl. No.: 14/640,897

(22) Filed: Mar. 6, 2015

Related U.S. Application Data
(60) Provisional application No. 62/044,245, filed on Aug. 31, 2014.

(51) Int. Cl. G06F 9/44; G06F 9/45; G06F 11/36

(52) U.S. Cl. CPC G06F 8/20; G06F 8/10; G06F 8/30; G06F 8/34; G06F 11/3668; G06F 11/3664; G06F 8/71; G06F 8/40

(57) ABSTRACT

Methods and apparatuses for interactively creating programs for digital computers or devices are provided. A programmer interacts with a computer to direct it to create and modify fragments of programs directly in a standardized Arithmetic or Logical Code (ALC) format recognized by the computer. Such ALC can be directly tested for errors, be presented in familiar source code form for review, and can be translated into executable programs of targeted platforms. The ALC parts can be shared and collected and archived over time, providing efficient code reuse. The methods and apparatuses provided by current invention can be used in all fields requiring programming of computers or devices to speed up product development and to reduce defects.

### CROSS-REFERENCE TO RELATED APPLICATIONS

Current application claims priority from U.S. Provisional Patent Application, No. 62/044,245, entitled “Methods and Apparatuses for Interactive Computer Programming”, filed on Aug. 31, 2014 by current inventor, and that application is incorporated herein as The Provisional.

### FIELD OF INVENTION

The current invention relates to the field of information technology development. Specifically, the current invention can be used in design and development of computer programs, including any software, firmware, hardware, embedded system and operating system developed using any script or programming language, on any software or hardware platform.

### BACKGROUND OF INVENTION

The invention and widespread application of digital computers is one of the biggest progresses in human civilization which greatly facilitates exchange of information, improves all productivities and efficiencies and generally makes our lives better. All computers, from a big database server to a small microcontroller in a bread toaster, must run on computer programs.

However, computer programming is a labor intensive and error prune process. Best minds with strong analytical skills are educated and trained to learn the skills to create programs vital to the modern economy. Mistakes in computer codes, called bugs, are common. A single bug in a mission critical computer program can cause catastrophic failure and un-measurably huge losses and damages. The information technology industry spends lots of efforts to improve and maintain products and eradicate bugs. But progress is slow, the result is not ideal while the cost is high. For example, Microsoft claims that its released software products contain an average of 0.5 bugs per TLC (Thousand Lines of Code). In-house testing code could contain 10 to 20 bugs per TLC. Large software projects can contain millions of lines of code and lots of bugs. Globally $325 billion a year is spent to test, maintain, and debug computer code.

In traditional computer program development, programmers edit computer source code in human readable text form, according to rules in a programming language, like C or C++, defined by groups of computer experts. The source code is saved to multiple source files, then processed by a compiler to parse the source code to interpret symbols and statements to generate sequences of computer instructions, and to link pieces together into the final executable program.

This process is time consuming and error prune. Each step must be done correctly to produce a correct executable program. The source code must be written with no syntax or logical error. The compiler must parse and interpret the source code correctly, and produce sequences of machine instructions correctly. Finally the computer must run in an expected environment. Event unexpected event should not happen. In reality things are not ideal. Human are prune to errors. Compilers are buggy. The platform to run executable programs can be different. The IT industry works hard to test software to detect and fix bugs. The process is time consuming and inefficient. Each step of the cycle: code editing, compiling and building the program, running repeated tests, is time consuming. Final result is not guaranteed.

Thus a more efficient way of computer programming is needed. Current invention seeks to improve the inefficiency of traditional computer programming by providing better, more efficient, and less error prune methods and apparatuses for computer program development. The result is big cost savings and higher quality software products.

### SUMMARY OF INVENTION

The present invention provides methods and apparatuses for efficient and accurate computer programming, with the benefit of greatly improved productivity and product quality in the field of computer program development. By recognizing the weaknesses of the traditional methods of computer programming, the present invention provides radically different methods and apparatuses to eradicate such weaknesses, results in great improvement of efficiency and quality of computer program developments.

Traditionally, a programmer write human readable computer source code according to pre-defined syntax and rules based on a pre-defined programming language like C or C++. The set source code files is then processed by a compiler to interpret the symbols and statements, according to the same syntax rules to generate the executable program. Finally the executable program is executed repeatedly under different conditions to confirm it works according to the original design. This process is inefficient and error prune. Programming errors often escape programmer and compiler checks and do not manifest into noticeable problem until after many hours of tests. Many bugs are not discovered until it is too late or too costly to fix those bugs.

Human beings are weak in memorizing things precisely and following rules strictly. So mistaken will happen if we rely on a programmer to remember things precisely and follow rules strictly. On the other hand, a computer is good at memorizing things exactly and following rules precisely. Human beings are weak in describing precisely the ideas in his/her mind, but are sharp in recognizing that something stated is not in compliance with what's in the minds, or is in conflict with memory, or unexpected. For example we cannot remember the exact name of the famous groundhog in Pennsylvania. But when we hear the name Punxsutawney Phil we realize immediately that that is the name of the famous groundhog. In a word, we are not good at giving exactly names and answers. But we are good at selecting choice items and making corrections.

Human beings are also weak in narrating objects or concepts in text form, but are strong in forming perception and making judgments. In general, we are weak in creating things but are strong in evaluating them. We have difficulty creating any artistic or creative pieces, but can immediately decide if we like a special work piece or not, be it art work or computer code.

Based on the consideration of the strength and weakness of human and computer, current invention devises a more reasonable scheme of computer programming. The programmer is not forced to memorize exactly language syntax rules. Instead he/she only needs to be familiar with them and recognize them when seeing them. The computer will remember the syntax rules and carries them out precisely. The computer will generate programs and present them in source code form for a programmer to review and evaluate, not the other way around. Thus a computer language becomes a languages that a computer uses to talk to a programmer, not a language that a programmer uses to talk to a computer.

Instead, a programmer will interact with a computer and direct it to generate desired programs in a variety of flexible, human friendly ways. The computer tries to understand what a programmer intends to do, in each of the steps, not by parsing source code a programmer enters, but by a variety of human interactions, like by recognizing the speech of the programmer, by capturing the mouse clicking and dragging, or screen touching on a variety of buttons or objects displayed on a computer display screen, or by hot keys pressed. The actions recognized, called Arithmetic and Logical Code (ALC), will be instantly translated into standard computer source code and displayed. The programmer can correct errors if the source code is different from what the programmer intends it to be.

The computer will also archive, maintain and retrieve collections of a knowledge body of fragments of programs, including code fragments, functions, algorithms, libraries. Such a collection of knowledge body of programs can be accumulated over time, be stored locally or be shared in a remote database server. Based on a programmer's need, a computer will search its body of knowledge and present relevant code fragments to the programmer for suggested usage. For example, a programmer wants to sort an array in ascending order. A computer will search its knowledge archive to identify any available code fragments or functions that does the sorting, and present them to the programmer. The programmer selects the suitable choice. The computer instantly inserts the code segment or function call, without the programmer editing anything. By leveraging a knowledge body of computer programming, a programmer saves time by not having to re-invent the wheel or re-write existing code.

Such interactive programming process will be faster and more accurate. Since ALC code is generated by a computer, not by a programmer, there will be no source code errors. Since a computer knows the ALC code, and the source code is generated by the computer itself, there is no need to parse the source code to generate the ALC code, thus the compilation process is reduced to merely turning the ALC code into machine instructions. In fact, there is no more separate compilation and testing process. The ALC code is instantly checked for correctness as they are entered interactively. The status of such checking is constantly updated and tracked. By the time a programmer finishes a part of the code, like a function call, it is already validated, and is likely to be correct, without running the final executable program. When a complete software project is finished, a full executable program is already generated with a high confidence that it likely will work straight. Thus the time to compile and build program is eliminated, and hours of final testing required is greatly reduced.

The essence of the current invention described can be summarized as the following:
1. The programmer directs a computer to create the Arithmetic and Logical Code (ALC) by interacting with a computer to select suggested code pieces, putting pieces together and making changes and corrections, aided by the computer, instead of typing source code.
2. The computer promptly translates the ALC into source code and displays it in a format familiar to the programmer, for review and correction. The programmer corrects the ALC as necessary, in an interactive way as described above.
3. The programmer defines how the ALC code should be tested, or allow the computer to make that decision. Each ALC fragment is promptly examined and tested for errors, as the programmer continues with the interactive process. Test results are instantly updated and tracked, keeping the programmer informed.
4. The process is repeated for ALC fragment of the computer program being developed, including definition of data types and data structures, classes, templates, functions etc.
5. When all ALC units of a computer program have been created based on design, and each unit has been validated, the whole program is tested and translated into an executable program. The final executable program then goes through regular final quality tests.

As evidenced from above description, the current invention provides methods and apparatus for interactive computer programming which is radically different from the prior art methods, which rely on programmers to create source files that must be in strict compliance of the programming language syntax rules. Instead, the programmer will directly tell the computer what do to, using interactive steps. The computer will generate syntax-correct source code, or in other easily recognizable visual symbols, like flow charts or other visual objects, for a programmer to exam for logical, mathematical or operational mistakes. By liberating programmers from the error prune burden of having to memorize and carry out the strict programming rules, a programmer's productivity is greatly increased, and the quality of computer programs produced is vastly improved.

The main novelty in current invention lies in two aspects as described below.

First, the programming process concentrated on creating the ALC code which is directly recognized by the computer. This compares to the traditional way of creating source code first and then compiling source code into machine readable object file and executables.

Second, a computer creates the ALC code, directed by programmer interactions, with leverage of a body of knowledge of programming, dynamically accumulated over time. This compares to the traditional way of a programmer typing and editing source code, and going out of his way to use existing static libraries and reuse any source code found locally or on the internet, all without much help from a computer.

By allowing a computer to create its ALC code that it recognizes and understands, directed by a programmer interactively, a lot of human inefficiency and errors are eliminated. The ALC code is readily tested and validated instantly, saving the time cost cycle of having to compile the code and then manually test final executables to find bugs. The ALC code can be accurately translated to familiar visual formats for a programmer to review easily, and can be readily translated to platform specific executable programs for the final tests.

By allowing a computer to dynamically archive, maintain, search and retrieve a knowledge body of programming, it allows quick, accurate and efficient reuse of past codes without the programmer having to struggle to find the coding snippets or re-invent the wheels. Based on claim 8, a standard for ALC will be defined to widely facilitate such code sharing.

There has been some prior art of attempting to use a computer to aid the computer programming. For example, U.S. Pat. No. 4,455,619 with a priority date May 30, 1980, provided an apparatus for assistance of constructing a data flow chart which directs the operation of a computer, by displaying the flow chart and allowing a user to use a keyboard to make changes. This prior art is fundamentally different from current invention, as current invention requires no flow chart, and is designed for general purpose computer programming, not carrying out a few limited actions based on a flow chart. Besides, the prior art involves no computer source code, while as in the current invention, the computer generates source code for a user to review.

More recently, modern computer compilers like Microsoft Visual Studio provide features to allow a user to create template projects. In such prior art, a user can select a type of new projects from a variety of selection. A set of source files are then automatically generated from pre-defined templates, allowing the programmer to continue to expand the source files from the template source files created. Such prior art merely generates a framework of bare minimum source code, and does not liberate the user from the duty of creating and editing source code. Moreover, the program compilation and building involves the traditional steps of parsing source files to understand what the programmer intends the program to do, and the testing is done only on the produced executable program. Such prior art is also different from the current invention.

Another prior art the current inventor noticed is US Pat. 20110145703, with a priority date Dec. 10, 2009. The prior provides a graphical user interface allowing a user to select and enter information which causes certain printing code to be generated and sent to a printing device, leading to the designed content, like a bar code, to be printed. The prior art is limited to a printing device, and involves no source code or computer instruction. Thus the prior art is quite different from current invention, which is for general purpose programming.

In summary, there is no known prior art which provides any method or apparatus for interactively creating general purpose computer programs like current invention does. Therefore, the current invention is both novel, none-obvious and useful, and can be reduced into practice by someone reasonably skilled in the art of the related fields.

### BRIEF DESCRIPTION OF DRAWINGS

FIG. 1 shows the work flow of traditional computer software development cycles. A project starts with a design and with the programmer editing source code. Through each iterated cycle of compilation, linking program, alpha test, beta test, product release, if any error happens the programmer goes back to edit the source code further and repeat the process, until all known errors are eliminated and final product is released. Since the cycle time is long and source code editing is a labor intensive and error prune process, the work flow is inefficient.

FIG. 2 shows the work flow according to methods provided by current invention. A computer generates standardized Arithmetic and Local Code (ALC) in a format it recognizes, directed by the control and interaction of a programmer. The computer represents the ALC in a source code familiar to the programmer, does instantaneous test to validate the ALC code, and translate the ALC code into executable program when ready. The computer can either be located locally or be accessed remotely through a network. The programmer can be a human or a device. Since a computer works best on ALC it generates and readily recognizes, it can carry out these tasks fast and accurately, the productivity efficiency and accuracy is greatly improved.

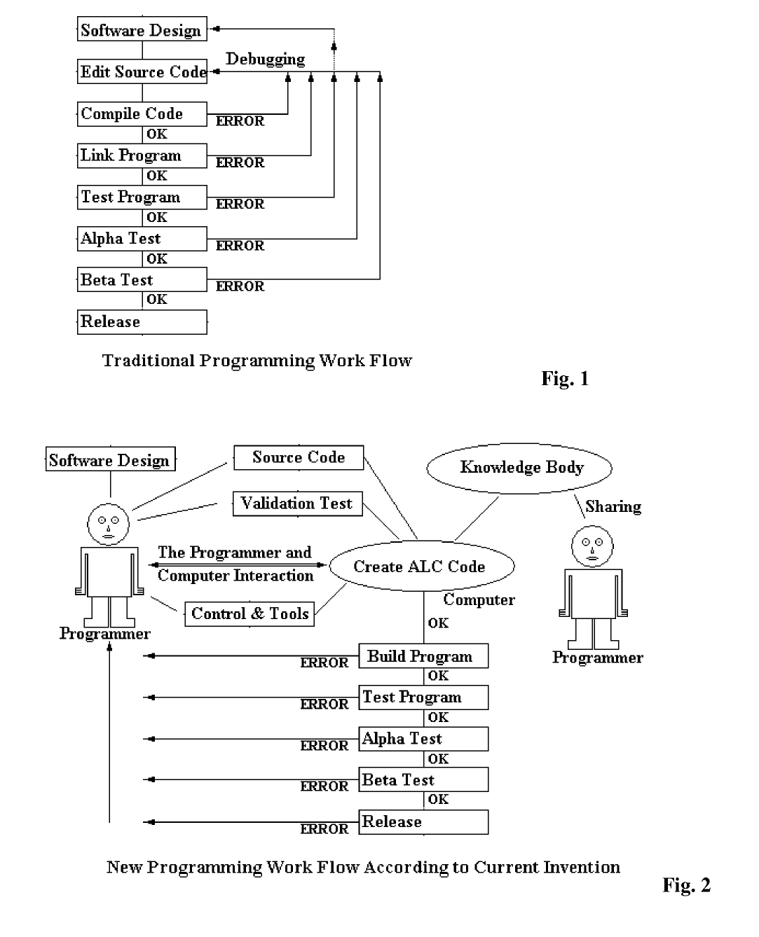

### DETAILED DESCRIPTION OF INVENTION

The current invention provides methods and apparatuses for interactive creation of computer programs, by allowing a programmer to interact with a computer through multiple user-friendly methods to create and modify Arithmetic and Logic Code (ALC) step by step, allowing the computer to validate the ALC and generate syntax correct source code instantly for the programmer to review. Such invented methods and apparatuses liberate a programmer from the burden of following syntax rules, and eliminate the steps to parse source code to generate ALC code before turning them into executable machine code. Thus current invention has the benefit of greatly increased programmer productivity and improved production quality, bringing great cost savings to the information technology industry.

The essence of the current invention is explained previously in the brief summary section. The current invention is further explained in detail by embodiment examples presented.

### Embodiment Example One

In embodiment Example One, referring to claim 1 step 1A, we will design a simple console program to print current date and time. Traditionally a programmer would type in a text source file like below, then run the compiler to create an executable program from it:

```
#include <windows.h>
#include <stdio.h>
int main(int argc, char* argv[ ]) {
  int  year, month, day, hour, minute, second;
  SYSTEMTIME  sysTime;
  GetSystemTime(&sysTime);
  year = sysTime.wYear; month = sysTime.wMonth;
  day = sysTime.wDay;
  hour = sysTime.wHour; minute = sysTime.wMinute;
  second = sysTime.wSecond;
  printf(“Current time is %d/%d/%d %02d:%02d:%02d\r\n”,
    month, day, year, hour, minute, second);
  return 0;
}
```

In embodiment Example One, the current invention provides a much easier and more reliable way of creating a computer program doing the same thing:

Step 1. Referring to claim 1 step 1B, the computer displays a variety of action icons. We can use a mouse to click and drag a console application icon into a main program window. A framework console program is generated, represented by internal operation code. All the relevant source code is generated and can be viewed in a separate window.

Step 2. Referring to claim 3, there are a variety of tools to select from. We can click and drag a printer icon to the main program window. An ALC code corresponding to a call to the printf( ) function is generated. The source code window is updated to reflect the change. Now we right click on the dropped printer icon, and we can type the text to print: “Current time is \r\n”.

Step 3, refer to claim 2, the computer has a programming knowledge body we can leverage. We click and drag a clock icon into the main program window, to near the printer icon and drop the icon there. The computer knows that you want to obtain the time. From a computer knowledge base it decides that it should call GetSystemTime( ), so the call is added instantly, so are the local variables, the result is added to the content to be printed, in a default format. All these steps are done in the internal ALC code. Now right click on the dropped clock icon again, it allow you to select one of several possible ways of formatting the time for print out.

Step 4. Referring to claim 1 step 1F and 1G, click the menu to generate and save everything. The program is saved in internal ALC code format, but not the source code, and a compiled executable program is created for you. The source code can be generated from the operation code at any time for review. So there is no need to save the text source code ever.

Referring to claim 1 step 1C and 1D. While the above actions are carried out, the computer instantly generates the source code and validates its correctness. The computer takes care of syntax rules and code testing for the programmer. The programmer only need to tell the computer what to do: Create a console window, get the time, and print the time. The computer figures out how to do these things for you, and generates the ALC code on its own.

### Embodiment Example Two

In embodiment Example Two, we will create a simple C++ class like below:

```
class MyClass {
  int a;
  int b;
public:
  MyClass( ) {a=0; b=0;}
  void Add(int val) {a++; b+= val;}
  int Count( ) {return a;}
  int Total( ) {return b;}
};
```

Step 1, right click on the NEW button and select CLASS as the object to create. A new class type is created in operation code, complete with the default constructor and destructor. Drag the destructor to the trash can as we do not need it. You can click to give the new class a name, or just leave it at the default name for now. Alternatively the computer can propose a number of similar classes from its knowledge base, as a template to use to construct the class.

Step 2, click and drag the Integer icon and drop it onto the block representing the new class. Do it twice. Now the class has to integer data members with different default names. You can click to change their names, or just leave them with their default names for now.

Step 3, click and drag the Function icon and drop it onto the block representing the new class. Do it three times. Now the class has three function members of unique default names. You can leave them with the default name or click to change their names. Names do not matter, as they already have unique names and different colors for identification. You identify them as individual icons as you manipulate them to construct your program. Remember human beings are better at recognizing small objects, than remembering their names. Again internal ALC code is generated first, and then presented to the programmer in familiar source code format.

Step 4, click and drag the Integer icon onto the head of first function. It becomes the first parameter of the function call. Drag the two class data members and drop them into the middle of the first function. They become data to be modified. Right click the first and select ++. That data member is incremented within the function. Drag the call parameter and drop it onto the second data member which was dropped within the function. That data member is increased by the call parameter. Thus the first function is completed as {a++; b+=val;}.

Step 5, click and drag the first data member to the tail of the second function, and do the same for the second data member and third function. They respectively become the return value of the respective functions, and the functions are now completed, as is the class. You still have to name the data and function members. But it does not matter as the features are complete.

So in a few simple actions, the ALC code is generated. Referring to claim 4, the ALC code is promptly translated to source code and displayed. Referring to claim 5, test is also done automatically to validate that the code works as intended. These steps are highly reliable.

The essential principle of the current invention is that the computer is a powerful tool which can help us express what we want to do quickly, without the tedious typing and the struggle to fix typos and syntax errors. Typing text files to create source code is a legacy left over from early days of command line based computers. In today's computing world of powerful graphical user interface, we should use the power of user friendly human computer interactions.

The above embodiment examples can be expanded to create any data type, class, function, object, variable, expression, statement, and other components of computer programs. The principle is the same, utilizing powerful graphical user interface to tell the computer what we want to do, instead of using source code. Let the computer generate source code to show us. The programmer concentrates on what to do. The computer to decide how to do it. Referring to claim 8, an ALC standard can be defined to allow ALC code to be widely shared and reused.

Practical embodiments of methods provided by current invention can vary greatly for improvements and for better usage. All such variations do not deviate from the basic principle of interactive creation of computer programs by utilizing human-computer interaction techniques that are user friendly, and the principle of allowing a computer to generate syntax correct source codes for a programmer to review, instead of asking a programmer to generate such source code by typing or other means. Thus all such embodiments are within the scope of current invention.

Referring to claim 3, the programmer that interacts with a computer to produce a computer program interactively as provided by current invention, may be a human programmer or a computer or device that interacts with the programming computer, which may locate locally or remotely, and which can be accessed directly or through a network. All such variations in embodiments do not deviate from the principle that interaction with the computer, rather than source code, is used for generating computer programs. Thus all such variations are considered to be included within the scope of the current invention.

In improved embodiments, even if a programmer let a computer know the intended computational actions interactively as provided by current invention, the computer may choose an alternative way to do the computation to better meet the computation requirements, based on information from the programming knowledge body. For example the computer may decide to use a look up table instead of carry out the computation required by the programmer. For another example, the programmer simply speaks “Tell me the time”, and the computer recognizes the speech and generates proper ALC code to acquire time, similar to embodiment Example One. Such improved or varied embodiments do not deviate from the principles that a programmer tells a computer what to do, but let it decides how to do it, and not feeding source code to a computer and asking the computer to interpret the source code according to the strict language rules. All such improvements and variations, whether explicitly mentioned in this document or not, shall be considered to be included within the scope of the current invention.

### Novelty, Non-Obviousness and Useful Value of Current Invention

Claims of current invention are novel ways of computer programming. In prior arts, a programmer generates syntax correct source codes for a computer to interpret into executable programs. In current invention, a computer generates ALC code based on user interactions, and present it to the user in easily recognizable visual formats for examination and correction. As we are better in recognizing things and making choices, current invention can boost productivity.

The current invention is also non-obvious. Ever since computers were invented, they must run on programs written by programmers. All efforts were made to make sure that both the computers and the programmers can fully understand the source code written to be turned into executable programs, and to ensure that the computer will do precisely what's specified in the source code, with no deviation, as any deviation will result in the wrong computation result. Complicated programming languages were invented to enforce strict language rules, both on programmers, and on computers interpreting source codes. Compiler software is designed to parse and interpret source code precisely, with no ambiguity and no deviation allowed. That has always been how programming is done. It is taught to every generations of programmers. So it is deep in the minds of people they need to write high quality source code to program a computer.

Thus it is not obvious that programming can be done better, without any source code, and that source code is merely a way a computer tells us what it intends to do, not a way we use to tell a computer what to do. This non-obvious but more effective approach is the essence of the current invention. Thus the current invention has both the novelty and non-obviousness.

The methods and apparatuses provided by the current invention are very useful and extremely valuable to the information technology industry. Productivity and product quality will be greatly improved, as programmers do not have to memorize strict language rules, and do not have to struggle with typing code correctly without making syntax error or forgetting something. Programming becomes the fun actions of manipulating pieces of blocks and icons on the screen, with no worry about type safety and other nuisances, as the computer takes care of the details. Bug rates will drop significantly. Programmers will have to dedicate much less resources in bug fixings, and can more projects faster, with much higher quality. Thus the value is tremendous.

### INDUSTRY APPLICABILITY

The current invention is novel, useful and non-obvious and can be utilized in the industrial application of information technology or any sector that requires programming of a digital computer or an automatic device which functions according to a pre-designed program.

The current inventor claims:

1. A method of creating a program for a computers or device, comprising steps of:
1A. Designing parts of program based on requirements of desired features and functions;
1B. Creating parts of program in a form recognizable by an automatic computer or device, based on input and interaction of a programmer, which can be a human or a non-human;
1C. Translating and presenting parts of program in step 1B, to a programmer, in a plural of audio or visual forms familiar to a programmer to allow review and evaluation;
1D. Testing parts of program in step 1B and presenting the test result to a programmer, in a plural of audio or visual forms familiar to a programmer to allow review and evaluation;
1E. Allowing modification of parts of program in step 1B, depending on step 1C and 1D;
1F. Storing all or parts of program created for archiving for later retrieval and usage;
1G. Translating all or parts of program created to an executable program suitable for a target execution platform, allowing further test and distribution of the finished program.

2. A method in accordance to claim 1, where a knowledge body of programs is created, maintained, archived, searched and retrieved to assist steps in claim 1, comprising steps of:
2A. Storing parts of program as provided claim 1 step 1F, either locally or on a remote database server, in forms suitable for easy archiving, categorizing, search and retrieval;
2B. Maintaining and updating a collection of knowledge body obtained in step 2A, by collecting and storing program parts obtained from a plurality of programmers working on a plurality of different projects, and accumulating such program parts over time;
2C. Making the knowledge body available by searching the knowledge body, in claim 1 step 1B, based on programmer input and interaction, and presenting relevant parts of program to be selected by the programmer for optional usage in a current work project.

3. A method in accordance to claim 1 step 1B, wherein a plurality of tools and ways are provided to allow a programmer to interact with a computer or device, in order to control and direct the creation and modification of said parts of program as described. Said interaction with a computer can be done locally or remotely via a network connection or an internet web interface.

4. A method in accordance to claim 1 step 1C, wherein the parts of program, in a form recognizable by a computer or device, is translated and formatted into comprehensible forms and presented to a programmer, according to rules of a computer language and a preference of format. Said translation can be done by a local computer or by a remotely accessed computer server.

5. A method in accordance to claim 1 step 1D, wherein the parts of program, in forms recognizable by the computer or device, is tested for correctness, under test conditions that can be specified, and the test result is presented and used for any needed modification in step 1E. Said testing can be done by a local computer or by a remotely accessed computer server.

6. A method in accordance to claim 1 step 1F, wherein parts of program, test results and intermediate works are stored in suitable forms, for archiving, retrieval, sharing and distribution. Said storage can be done at a local computer or at a remotely accessed computer server.

7. A method in accordance to claim 1 step 1G, where all or part of program is translated to executable program suitable on a target platform, for testing, packaging and distribution. Said translation can be done by a local computer or by a remotely accessed computer server.

8. A method in accordance to claim 1 step 1A and 1B, wherein a universal standard is designed to describe any algorithm or any arithmetic, logical or control operations uniquely in a form independent of device platforms, by easily recognizable by any devices, thus to facilitate creation, modification, storage, retrieval and sharing of parts of program as described in claim 1.

9. An apparatus of embodiment using the method according to claim 1, composing of a computer or a device running a program providing functionalities and features as described.

10. An apparatus of embodiment using the method according to claim 2, composing of a computer or a device running a program providing functionalities and features as described.

11. An apparatus of embodiment using the method according to claim 3, composing of a computer or a device running a program providing functionalities and features as described.

12. An apparatus of embodiment using the method according to claim 4, composing of a computer or a device running a program providing functionalities and features as described.

13. An apparatus of embodiment using the method according to claim 5, composing of a computer or a device running a program providing functionalities and features as described.

14. An apparatus of embodiment using the method according to claim 6, composing of a computer or a device running a program providing functionalities and features as described.

15. An apparatus of embodiment using the method according to claim 7, composing of a computer or a device running a program providing functionalities and features as described.

16. An apparatus of embodiment using the method according to claim 8, composing of a computer or a device running a program which provides interpretation, and translation to and from the said universal standard, to describe algorithm, arithmetic, logical or control operations.
